(19) United States
(12) Patent Application Publication
(10) Pub. No.: US 2020/0041101 A1
(43) Pub. Date: Feb. 6, 2020

(54) WAVELENGTH CONVERSION FILM

(71) Applicant: Chunghwa Picture Tubes, LTD., Taoyuan City (TW)

(72) Inventors: Wen-Jiunn Hsieh, New Taipei City (TW); Chao-Wen Yeh, Taoyuan City (TW)

(73) Assignee: Chunghwa Picture Tubes, LTD., Taoyuan City (TW)

(21) Appl. No.: 16/149,072

(22) Filed: Oct. 1, 2018

(30) Foreign Application Priority Data
Aug. 1, 2018 (CN) 201810862714.1

(51) Int. Cl. F21V 9/38; F21K 9/64; F21V 13/02; C09K 11/08

(52) U.S. Cl. CPC F21V 9/38; C09K 11/08; F21V 13/02; F21K 9/64

(57) ABSTRACT

A wavelength conversion film including a phosphor layer and a light scattering layer is provided. The phosphor layer includes a first phosphor and a first substrate. The light scattering layer includes a plurality of titanium dioxide particles and a second substrate. The wavelength conversion film further includes a photoluminescence material and a plurality of nanoparticles. The photoluminescence material and the plurality of nanoparticles are located in at least one of the phosphor layer and the light scattering layer or respectively located in the phosphor layer and the light scattering layer. The wavelength conversion film of the invention may prevent the occurrence of photocatalytic effect and increase the light conversion efficiency.

### CROSS-REFERENCE TO RELATED APPLICATION

This application claims the priority benefit of China application serial no. 201810862714.1, filed on Aug. 1, 2018. The entirety of the above-mentioned patent application is hereby incorporated by reference herein and made a part of this specification.

### BACKGROUND OF THE INVENTION

### Field of the Invention

The invention relates to a wavelength conversion film.

### Description of Related Art

In general, the existing wavelength conversion film includes a phosphor and a plurality of titanium dioxide particles. The phosphor may absorb a portion of blue light emitted from a light emitting device (e.g., a light emitting diode) and convert it into visible light. The plurality of titanium dioxide particles may scatter a portion of blue light emitted from the light emitting device, so that the blue light may be guided to the phosphor and converted into visible light. Further, since the plurality of titanium dioxide particles has a white color, the wavelength conversion film also has a white appearance when the light emitting device is turned off. However, ultraviolet light emitted from the light emitting device may cause the photocatalytic effect on the plurality of titanium dioxide particles. Thus, the degradation of polymer materials in the wavelength conversion film and the light emitting device due to the photocatalytic effect may cause the deterioration of the quality of the wavelength conversion film and the light emitting device.

### SUMMARY OF THE INVENTION

The invention provides a wavelength conversion film that can prevent the occurrence of photocatalytic effect and increase the light conversion efficiency.

Other objects and advantages of the present invention will be understood by the following description, and the invention will be made more apparent by the specific embodiments disclosed in the present invention.

The invention provides a wavelength conversion film including a phosphor layer and a light scattering layer. The phosphor layer includes a first phosphor and a first substrate. The light scattering layer includes a plurality of titanium dioxide particles and a second substrate. The wavelength conversion film further includes a photoluminescence material and a plurality of nanoparticles. The photoluminescence material and the plurality of nanoparticles are located in at least one of the phosphor layer and the light scattering layer or respectively located in the phosphor layer and the light scattering layer.

According to an embodiment of the invention, the photoluminescence material is located in the phosphor layer, and the plurality of nanoparticles are located in the light scattering layer.

According to an embodiment of the invention, the plurality of nanoparticles are located in the phosphor layer, and the photoluminescence material is located in the light scattering layer.

According to an embodiment of the invention, the photoluminescence material and the plurality of nanoparticles are located in the light scattering layer.

According to an embodiment of the invention, the photoluminescence material and the plurality of nanoparticles are located in the phosphor layer.

According to an embodiment of the invention, the photoluminescence material includes a second phosphor.

According to an embodiment of the invention, a content of the second phosphor in the photoluminescence material is between 5 wt % and 50 wt %.

According to an embodiment of the invention, the second phosphor includes BaMgAl:Eu, BaMgAl:Eu,Mn, GdOS:Eu, Y₂O₃:Eu, YVO₄:Nd, or a combination thereof.

According to an embodiment of the invention, an appearance color of the photoluminescence material is white.

According to an embodiment of the invention, a weight ratio of the plurality of nanoparticles to the photoluminescence material is between 0.01 and 0.5.

According to an embodiment of the invention, the plurality of nanoparticles include a metal material or a semiconductor material, and the metal material includes gold, silver, platinum, copper, aluminum, or a combination thereof.

According to an embodiment of the invention, a particle size of the plurality of nanoparticles is between 0.5 nm and 100 nm.

According to an embodiment of the invention, the first phosphor includes a phosphor emitting yellow light, green light, or red light excited by blue light. The first phosphor includes, for example, yellow fluorescent powders (e.g., yttrium aluminum garnet, YAG:Ce³⁺), green fluorescent powders (e.g., β-sialon), or red fluorescent powders (e.g., manganese-doped potassium fluorosilicate (KSF), potassium fluorogermanate (KGF) or potassium fluorotitanate (KTF)).

According to the wavelength conversion film in the embodiment of the invention, since the wavelength conversion film includes the plurality of nanoparticles and the photoluminescence material that can absorb ultraviolet light, the photocatalytic effect occurred from the plurality of titanium dioxide particles irradiated by ultraviolet light in the wavelength conversion film can be prevented. Thereby, deterioration of the wavelength conversion film and the light emitting device can be prevented. Besides, since the plurality of nanoparticles and the photoluminescence material have the function of converting ultraviolet light into visible light, at least one of the plurality of nanoparticles and the photoluminescence material may partially replace the first phosphor according to the manufacturing cost, and the content of the first phosphor in the phosphor layer is reduced.

In order to make the aforementioned features and advantages of the disclosure more comprehensible, embodiments accompanied with figures are described in detail below.

### BRIEF DESCRIPTION OF THE DRAWINGS

FIG. 1A is a schematic cross-sectional view illustrating a wavelength conversion film according to an embodiment of the invention.

FIG. 1B is a schematic cross-sectional view illustrating a wavelength conversion film according to another embodiment of the invention.

FIG. 2 is a schematic cross-sectional view illustrating a wavelength conversion film according to a still another embodiment of the invention.

FIG. 3 is a schematic cross-sectional view illustrating a wavelength conversion film according to a further embodiment of the invention.

### DESCRIPTION OF THE EMBODIMENTS

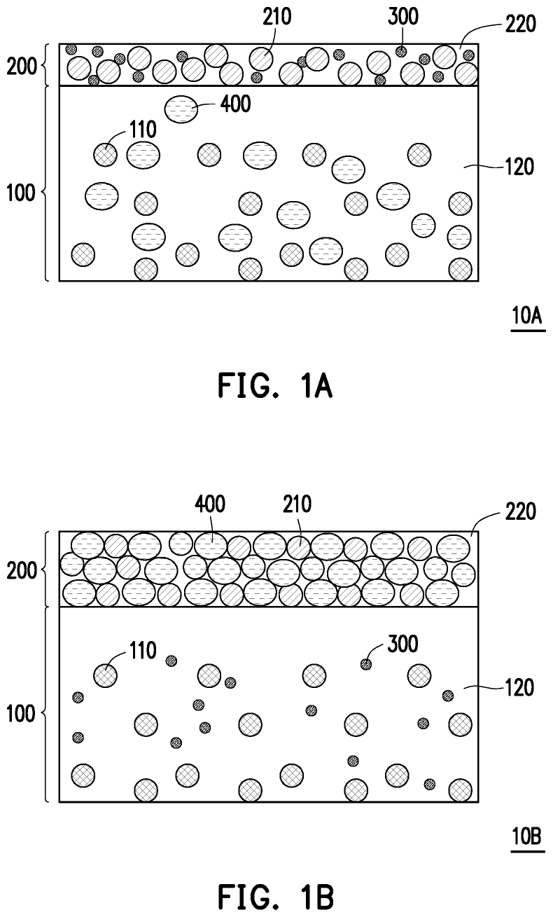

Referring to FIG. 1A, a wavelength conversion film 10A of the embodiment includes a phosphor layer 100 and a light scattering layer 200. In an embodiment, the wavelength conversion film 10A may be disposed remotely from a light emitting device (not shown) to form a light emitting package structure with the light emitting device. In other words, the wavelength conversion film 10A may be separated from the light emitting device by a certain distance, but the invention is not limited thereto. The light emitting device may be a light emitting diode (LED), for example, but the invention is not limited thereto.

In an embodiment, the phosphor layer 100 includes a first phosphor 110 and a first substrate 120. The first phosphor 110 may be an inorganic phosphor, an organic phosphor, or a combination thereof, for example. For instance, the first phosphor 110 includes a phosphor emitting yellow light, green light, or red light excited by blue light. Specifically, the first phosphor 110 includes, for example, yellow fluorescent powders (e.g., yttrium aluminum garnet, YAG:Ce³⁺), green fluorescent powders (e.g., β-sialon), or red fluorescent powders (e.g., manganese-doped potassium fluorosilicate (KSF), potassium fluorogermanate (KGF) or potassium fluorotitanate (KTF)). Thus, the first phosphor 110 may absorb blue light emitted from the light emitting device and convert it into visible light, such as yellow light, green light, red light, green light and yellow light, green light and red light, yellow light and red light, or other combinations of light. Based on this, the blue light emitted from the light emitting device that is not absorbed by the phosphor may be combined with the aforementioned light converted by the first phosphor 110 and may generate light having complementary colors to be superimposed to provide almost white light to human eyes. The first substrate 120 is a substrate layer used for carrying the first phosphor 110 and light transmitting, for example. The first substrate 120 may be a thermosetting resin or a photocurable resin, for example. For instance, a material of the first substrate 120 is an acrylic resin, a polysiloxane resin, or a combination thereof.

In an embodiment, the light scattering layer 200 includes a plurality of titanium dioxide particles 210 and a second substrate 220. A particle size of the plurality of titanium dioxide particles 210 is between 10 nm and 10 μm, for example, and preferably between 50 nm and 5 μm. The plurality of titanium dioxide particles 210 may reflect or refract blue light emitted from the light emitting device, such that the reflected or refracted blue light may be guided to the first phosphor 110 to improve conversion efficiency of the blue light. In addition, since the light scattering layer 200 includes the plurality of titanium dioxide particles 210 to have a high refractive index, the probability of total reflection of the blue light in the light scattering layer 200 may be improved, thereby improving the conversion efficiency of the blue light. Based on the above effects of the plurality of titanium dioxide particles 210, the content of the first phosphor 110 in the phosphor layer 100 may be reduced according to the manufacturing cost. The second substrate 220 is a substrate layer used for carrying the plurality of titanium dioxide particles 210 and light transmitting, for example. The second substrate 220 may be a thermosetting resin or a photocurable resin, for example. For instance, a material of the second substrate 220 is an acrylic resin, a polysiloxane resin, or a combination thereof.

In an embodiment, the wavelength conversion film 10A may further include a plurality of nanoparticles 300 and a photoluminescence material 400. In the present embodiment, the plurality of nanoparticles 300 are located in the light scattering layer 200, and the photoluminescence material 400 is located in the phosphor layer 100, but the invention is not limited thereto. In other words, the embodiment is only intended to specifically describe the features of the present invention, and thus the present invention should not be construed restrictively by the embodiment. A weight ratio of the plurality of nanoparticles 300 to the photoluminescence material 400 is between 0.01 and 0.5, for example. A material of the plurality of nanoparticles 300 may be a metal material such as gold, silver, platinum, copper, aluminum, or an alloy thereof, or a semiconductor material. The aforementioned material has a property such as a real part of dielectric constant with a negative value and an imaginary part of dielectric constant with a small value. In the present embodiment, the plurality of nanoparticles 300 are gold nanoparticles. A particle size of the plurality of nanoparticles 300 is between 0.1 nm and 200 nm, for example, and preferably between 0.5 nm and 100 nm. The plurality of nanoparticles 300 may absorb ultraviolet light emitted from the light emitting device and convert it into visible light, namely metal photoluminescence (MPL). Based on this, the plurality of nanoparticles 300 can prevent the photocatalytic effect occurred from the plurality of titanium dioxide particles 210 irradiated by ultraviolet light. Thereby, the deterioration of the wavelength conversion film 10A due to oxidation of organic matters in the wavelength conversion film 10A can be prevented. On the other hand, the plurality of nanoparticles 300 may also be used as the first phosphor 110, and thus the content of the first phosphor 110 in the phosphor layer 100 may be reduced according to the manufacturing cost. The photoluminescence material 400 is a material having a white appearance color, for example. Since the appearance color of the photoluminescence material 400 is white, the light scattering layer 200 may keep the white appearance when the light emitting device (not shown) does not emit blue light. In an embodiment, the photoluminescence material 400 includes a second phosphor and a transparent polymer material. The second phosphor includes BaMgAl:Eu, BaMgAl:Eu,Mn, GdOS:Eu, Y₂O₃:Eu, YVO₄:Nd, or a combination thereof. The transparent polymer material includes an acrylic resin, a polysiloxane resin, or a combination thereof. In an embodiment, a content of the second phosphor in the photoluminescence material 400 is between 5 wt % and 50 wt %, and preferably between 5 wt % and 20 wt %. The second phosphor includes BaMgAl:Eu, BaMgAl:Eu,Mn, GdOS:Eu, Y₂O₃:Eu, YVO₄:Nd, or a combination thereof. The second phosphor may absorb blue light emitted from the light emitting device and convert it into visible light. The photoluminescence material 400 may also reflect or refract the blue light emitted from the light emitting device, such that the reflected or refracted blue light may be guided to the first phosphor 110 to improve the conversion efficiency of the blue light. Therefore, the photoluminescence material 400 may partially replace the plurality of titanium dioxide particles 210 according the manufacturing cost, so as to reduce the content of the plurality of titanium dioxide particles 210 in the light scattering layer 200.

In the phosphor layer 100 of the present embodiment, the amount of the first phosphor 110 is preferably between 10 wt % and 50 wt %, and the amount of the photoluminescence material 400 is preferably between 5 wt % and 50 wt %. In addition, in the light scattering layer 200 of the present embodiment, the amount of the plurality of titanium dioxide particles 210 is preferably between 7 wt % and 35 wt %, and the amount of the plurality of nanoparticles 300 is preferably between 0.05 wt % and 25 wt %.

Based on the above, since the wavelength conversion film of the present embodiment includes the plurality of nanoparticles and the photoluminescence material that can absorb ultraviolet light, the photocatalytic effect occurred from the plurality of titanium dioxide particles irradiated by ultraviolet light in the wavelength conversion film can be prevented. Thereby, the deterioration of the wavelength conversion film and the light emitting device can be prevented. Besides, since the plurality of nanoparticles and the photoluminescence material have the function of converting ultraviolet light into visible light, the plurality of nanoparticles and the photoluminescence material may partially replace the first phosphor according to the manufacturing cost, and the content of the first phosphor in the phosphor layer is reduced. Also, since the photoluminescence material of the present embodiment has the function of reflecting or refracting blue light emitted from the light emitting device, the photoluminescence material may partially replace the plurality of titanium dioxide particles according the manufacturing cost, the content of the plurality of titanium dioxide particles in the light scattering layer is reduced.

FIG. 1B is a schematic cross-sectional view illustrating a wavelength conversion film according to another embodiment of the invention. It should be noted that the reference numerals and a part of the contents in the embodiments of FIG. 1A are used in the embodiments of FIG. 1B, in which identical or similar reference numerals indicate identical or similar elements, and repeated description of the same technical contents is omitted. The omitted part of the description can refer to the foregoing embodiment, which is not repeated in the following embodiment.

Referring to FIG. 1B, the difference between the embodiment shown in FIG. 1B and the embodiment shown in FIG. 1A is that the plurality of nanoparticles 300 are located in the phosphor layer 100 of a wavelength conversion film 10B, and the photoluminescence material 400 is located in the light scattering layer 200 of the wavelength conversion film 10B. As described in the aforementioned embodiment, since the wavelength conversion film 10B includes the plurality of nanoparticles 300 and the photoluminescence material 400, the conversion efficiency of ultraviolet light may be significantly improved.

In the phosphor layer 100 of the present embodiment, the amount of the first phosphor 110 is preferably between 10 wt % and 50 wt %, and the amount of the plurality of nanoparticles 300 is preferably between 0.05 wt % and 25 wt %. In addition, in the light scattering layer 200 of the present embodiment, the amount of the plurality of titanium dioxide particles 210 is preferably between 7 wt % and 35 wt %, and the amount of the photoluminescence material 400 is preferably between 5 wt % and 50 wt %.

Based on the above, since the wavelength conversion film of the embodiment includes the plurality of nanoparticles and the photoluminescence material that can absorb ultraviolet light, the photocatalytic effect occurred from the plurality of titanium dioxide particles irradiated by ultraviolet light in the wavelength conversion film can be prevented. Thereby, the deterioration of the wavelength conversion film and the light emitting device can be prevented. Besides, since the plurality of nanoparticles and the photoluminescence material have the function of converting ultraviolet light into visible light, the plurality of nanoparticles and the photoluminescence material may partially replace the first phosphor according to the manufacturing cost, and the content of the first phosphor in the phosphor layer is reduced. Also, since the photoluminescence material of the present embodiment has the function of reflecting or refracting blue light emitted from the light emitting device, the photoluminescence material may partially replace the plurality of titanium dioxide particles according the manufacturing cost, and the content of the plurality of titanium dioxide particles in the light scattering layer is reduced.

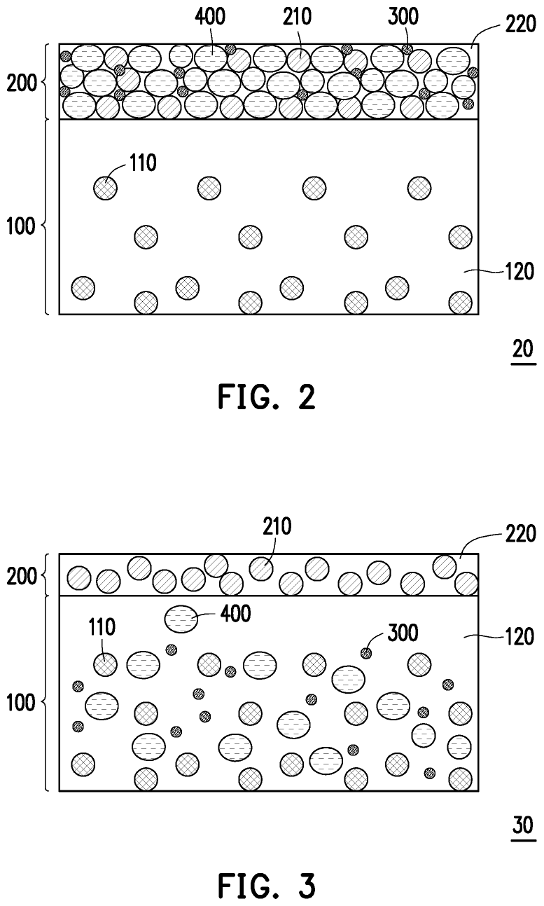

FIG. 2 is a schematic cross-sectional view illustrating a wavelength conversion film according to a still another embodiment of the invention. It should be noted that the reference numerals and a part of the contents in the embodiments of FIG. 1A are used in the embodiments of FIG. 2, in which identical or similar reference numerals indicate identical or similar elements, and repeated description of the same technical contents is omitted. The omitted part of the description can refer to the foregoing embodiment, which is not repeated in the following embodiment.

Referring to FIG. 2, the difference between the embodiment shown in FIG. 2 and the embodiment shown in FIG. 1A is that the photoluminescence material 400 is located in the light scattering layer 200 of a wavelength conversion film 20. That is, the plurality of nanoparticles 300 and the photoluminescence material 400 are both located in the light scattering layer 200. In the present embodiment, since the plurality of nanoparticles 300 and the photoluminescence material 400 are both located in the light scattering layer 200, the metal-enhanced fluorescence (MPL) is occurred between the plurality of nanoparticles 300 and the photoluminescence material 400. Thus, the conversion efficiency of ultraviolet light is significantly improved. Specifically, after the plurality of nanoparticles 300 absorb ultraviolet light and are excited by ultraviolet light, free electrons on the plurality of nanoparticles 300 will have periodic relative shifts with ions on the lattice. The relative shift will make charges accumulate on an opposite surface, resulting in localized electric field strength enhancement, namely a localized surface plasmon resonance (LSPR) effect. The localized surface plasmon resonance effect occurred from the plurality of nanoparticles 300 excited by ultraviolet light may further increase the conversion efficiency of ultraviolet light of the photoluminescence material 400. Therefore, the photoluminescence material 400 may partially replace the first phosphor 110 according to the manufacturing cost, so as to reduce the content of the first phosphor 110 in the phosphor layer 100. Besides, the photoluminescence material 400 may also reflect or refract blue light emitted from the light emitting device, such that the reflected or refracted blue light may be guided to the first phosphor 110 to improve the conversion efficiency of the blue light. Therefore, the photoluminescence material 400 may partially replace the plurality of titanium dioxide particles 210 according the manufacturing cost, so as to reduce the content of the plurality of titanium dioxide particles 210 in the light scattering layer 200.

In the phosphor layer 100 of the present embodiment, the amount of the first phosphor 110 is preferably between 10 wt % and 50 wt %, the amount of the plurality of nanoparticles 300 is preferably between 0.05 wt % and 25 wt %, and the amount of the photoluminescence material 400 is preferably between 5 wt % and 50 wt %. In addition, in the light scattering layer 200 of the present embodiment, the amount of the plurality of titanium dioxide particles 210 is preferably between 7 wt % and 35 wt %.

Based on the above, since the wavelength conversion film of the present embodiment includes the plurality of nanoparticles and the photoluminescence material that can absorb ultraviolet light, the photocatalytic effect occurred from the plurality of titanium dioxide particles irradiated by ultraviolet light in the wavelength conversion film can be prevented. Thereby, the deterioration of the wavelength conversion film and the light emitting device can be prevented. Besides, since the plurality of nanoparticles and the photoluminescence material have the function of converting ultraviolet light into visible light, and the plurality of nanoparticles and the photoluminescence material are located in the same layer such that the conversion efficiency of ultraviolet light is significantly improved, the plurality of nanoparticles and the photoluminescence material may partially replace the first phosphor according to the manufacturing cost, and the content of the first phosphor in the phosphor layer is reduced. Also, since the photoluminescence material of the present embodiment has the function of reflecting or refracting blue light emitted from the light emitting device, the photoluminescence material may partially replace the plurality of titanium dioxide particles according the manufacturing cost, and the content of the plurality of titanium dioxide particles in the light scattering layer is reduced.

FIG. 3 is a schematic cross-sectional view illustrating a wavelength conversion film according to a further embodiment of the invention. It should be noted that the reference numerals and a part of the contents in the embodiments of FIG. 2 are used in the embodiments of FIG. 3, in which identical or similar reference numerals indicate identical or similar elements, and repeated description of the same technical contents is omitted. The omitted part of the description can refer to the foregoing embodiment, which is not repeated in the following embodiment.

Referring to FIG. 3, the difference between the embodiment shown in FIG. 3 and the embodiment shown in FIG. 2 is that the plurality of nanoparticles 300 and the photoluminescence material 400 are both located in the phosphor layer 100 of a wavelength conversion film 30. As described in the aforementioned embodiment, since the metal-enhanced fluorescence is occurred between the plurality of nanoparticles 300 and the photoluminescence material 400 or between the plurality of nanoparticles 300 and the first phosphor 110, the conversion efficiency of ultraviolet light is significantly improved.

In the phosphor layer 100 of the present embodiment, the amount of the first phosphor 110 is preferably between 10 wt % and 50 wt %. In addition, in the light scattering layer 200 of the present embodiment, the amount of the plurality of titanium dioxide particles 210 is preferably between 7 wt % and 35 wt %, the amount of the plurality of nanoparticles 300 is preferably between 0.05 wt % and 25 wt %, and the amount of the photoluminescence material 400 is preferably between 5 wt % and 50 wt %.

Based on the above, since the wavelength conversion film of the present embodiment includes the plurality of nanoparticles and the photoluminescence material that can absorb ultraviolet light, the photocatalytic effect occurred from the plurality of titanium dioxide particles irradiated by ultraviolet light in the wavelength conversion film can be prevented. Thereby, the deterioration of the wavelength conversion film and the light emitting device can be prevented. Besides, since the plurality of nanoparticles and the photoluminescence material have the function of converting ultraviolet light into visible light, and the plurality of nanoparticles and the photoluminescence material are located in the same layer such that the conversion efficiency of ultraviolet light is significantly improved, the plurality of nanoparticles and the photoluminescence material may partially replace the first phosphor according to the manufacturing cost, and the content of the first phosphor in the phosphor layer is reduced. Also, since the photoluminescence material of the present embodiment has the function of reflecting or refracting blue light emitted from the light emitting device, the photoluminescence material may partially replace the plurality of titanium dioxide particles according the manufacturing cost, and the content of the plurality of titanium dioxide particles in the light scattering layer is reduced.

What is claimed is:

1. A wavelength conversion film, comprising:
a phosphor layer, comprising a first phosphor and a first substrate; and
a light scattering layer, comprising a plurality of titanium dioxide particles and a second substrate,
wherein the wavelength conversion film further comprises a photoluminescence material and a plurality of nanoparticles, and the photoluminescence material and the plurality of nanoparticles are located in at least one of the phosphor layer and the light scattering layer or respectively located in the phosphor layer and the light scattering layer.

2. The wavelength conversion film according to claim 1, wherein the photoluminescence material is located in the phosphor layer, and the plurality of nanoparticles are located in the light scattering layer.

3. The wavelength conversion film according to claim 1, wherein the plurality of nanoparticles are located in the phosphor layer, and the photoluminescence material is located in the light scattering layer.

4. The wavelength conversion film according to claim 1, wherein the photoluminescence material and the plurality of nanoparticles are located in the light scattering layer.

5. The wavelength conversion film according to claim 1, wherein the photoluminescence material and the plurality of nanoparticles are located in the phosphor layer.

6. The wavelength conversion film according to claim 1, wherein the photoluminescence material comprises a second phosphor.

7. The wavelength conversion film according to claim 6, wherein a content of the second phosphor in the photoluminescence material is between 5 wt % and 50 wt %.

8. The wavelength conversion film according to claim 6, wherein the second phosphor comprises BaMgAl:Eu, BaMgAl:Eu,Mn, GdOS:Eu, Y₂O₃:Eu, YVO₄:Nd, or a combination thereof.

9. The wavelength conversion film according to claim 1, wherein an appearance color of the photoluminescence material is white.

10. The wavelength conversion film according to claim 1, wherein a weight ratio of the plurality of nanoparticles to the photoluminescence material is between 0.01 and 0.5.

11. The wavelength conversion film according to claim 1, wherein the plurality of nanoparticles comprise a metal material or a semiconductor material, and the metal material comprises gold, silver, platinum, copper, aluminum, or a combination thereof.

12. The wavelength conversion film according to claim 1, wherein a particle size of the plurality of nanoparticles is between 0.5 nm and 100 nm.

13. The wavelength conversion film according to claim 1, wherein the first phosphor comprises a phosphor emitting yellow light, green light, or red light excited by blue light.
